(19) United States
(12) Patent Application Publication
(10) Pub. No.: US 2012/0154713 A1
(43) Pub. Date: Jun. 21, 2012

(54) LIQUID CRYSTAL DISPLAY

(75) Inventor: Jin Hyuk Kwon, Daegu (KR)

(73) Assignee: Industry-Academic Cooperation Foundation, Yeungnam University, Gyeongsan-si, Gyeongsangbuk-do (KR)

(21) Appl. No.: 13/393,072

(22) PCT Filed: Jan. 15, 2010
(86) PCT No.: PCT/KR2010/000274

§ 371 Date: Feb. 28, 2012

(30) Foreign Application Priority Data
Aug. 28, 2009 (KR) 10-2009-0080456

(51) Int. Cl. G02F 1/13357

(52) U.S. Cl. 349/64

(57) ABSTRACT

A liquid crystal display including: a liquid crystal panel including front and rear glass substrates, a plurality of liquid crystal sub-pixels for red, green, and blue respectively corresponding to three color, i.e., red, green, and blue, lights, and disposed between the front and rear glass substrates, and a color filter disposed between the plurality of liquid crystal sub-pixels and the front glass substrate; a backlight unit disposed behind the liquid crystal panel, and including a plurality of three color light suppliers spaced apart from each other in groups and supplying the three color lights; and a lenticular lens array disposed between the backlight unit and the liquid crystal panel, and inducing the three color lights emitted from the three color light suppliers to the liquid crystal sub-pixels and the color filter of the liquid crystal panel. According to the liquid crystal display, the lenticular lens array is attached to the liquid crystal panel so as to induce red, green, and blue lights respectively to red, green, and blue color filters inside the liquid crystal panel, thereby increasing light transmittance and decrease light loss. Accordingly, power consumption of the liquid crystal display is reduced, the liquid crystal display realizes high resolution, and manufacturing expenses of the liquid crystal display are reduced.

### TECHNICAL FIELD

The present invention relates to a liquid crystal display (LCD), and more particularly, to a LCD having decreased power consumption, having a decreased number of light emitting diodes (LEDs), and realizing a color image having high definition and high resolution, as light transmittance is improved by directly transmitting red, green, and blue light from a direct type LCD television respectively to red, green, and blue liquid crystal sub-pixels and red, green, and blue color filers, by using a lenticular lens array, wherein the red, green, and blue liquid crystal sub-pixels and the red, green, and blue color filters are sequentially installed on a liquid crystal panel.

### BACKGROUND ART

FIG. 1 is a cross-sectional diagram of a conventional direct type liquid crystal display (LCD), and FIG. 2 is a plan view illustrating a structure of color filters 24 installed inside a front glass substrate 25 of a liquid crystal panel 20 of FIG. 1.

First, referring to FIG. 1, the conventional direct type LCD includes the liquid crystal panel 20 including a liquid crystal pixel 23 operating as a light valve by adjusting transmittance of light, and a backlight unit 10 supplying light to the liquid crystal panel 20.

The backlight unit 10 includes a light source assembly 11 including one of a cold cathode fluorescence lamp (CCFL) 11a, external electrode fluorescence lamp (EEFL), white light emitting diode (LED), and RGB LEDs emitting red, green, and blue, and a reflector 11b disposed below the CCFL 11a. The backlight unit 10 further includes a plurality of optical sheets that reflect light emitted from the CCFL 11a at the reflector 11b, or scatter the light onto the plurality of liquid crystal pixel 23 by uniformly mixing the light therethrough. Here, the optical sheets include a diffusion plate 12, a diffusion sheet 13, a condensing sheet 14, a reflective polarizing sheet 15, and a protective film 16, and suitably adjusts viewing angle and luminance.

Hereinafter, R, G, and B respectively are abbreviations of red, green, and blue and will respectively denote red, green, and blue throughout without separate indication.

The liquid crystal panel 20 performs main optical functions by including a rear glass substrate 22, the front glass substrate 25, the plurality of liquid crystal pixels 23 disposed between the rear glass substrate 22 and the front glass substrate 25, the color filters 24 transmitting R, G, and B lights, and disposed inside the front glass substrate 25, a polarizing sheet 21 adhered on the rear glass substrate 22, and a polarizing sheet 26 adhered on the front glass substrate 25.

Each of the plurality of liquid crystal pixels 23 includes RGB liquid crystal sub-pixels respectively realizing RGB images, and the color filter 24 is disposed between each of the RGB liquid crystal sub-pixels and the front glass substrate 25.

Also, as shown in FIG. 2, a black matrix 27 for absorbing light is disposed between RGB color filters 24a, 24b, and 24c disposed on an inner side of the front glass substrate 25 according to the RGB liquid crystal sub-pixels, so as to prevent a color crosstalk.

A method of realizing a color image in the conventional direct type LCD will now be described. The conventional direct type LCD realizes a color image by disposing RGB liquid crystal sub-pixels for realizing RGB images in one liquid crystal pixel 23 constituting the minimum unit of a pixel, disposing the RGB color filters 24a, 24b, and 24c respectively in the front of the RGB liquid crystal sub-pixels, and passing RGB light respectively through RGB liquid crystal sub-pixels from white light emitted from the backlight unit 10. Here, it is seen that the color filter 24 is a core device for realizing a color image in the conventional direct type LCD.

However, in the conventional direct type LCD, a considerable amount of optical energy is lost at the polarizing sheets 21 and 26, an aperture ratio of the liquid crystal pixel 23, and the color filter 24, and thus the conventional direct type LCD consumes large amount of power. In detail, in the conventional direct type LCD, about 50% of optical energy is lost at the polarizing sheets 21 and 26, about 30% to about 50% of optical energy is lost at the aperture ratio of the liquid crystal pixel 23, and about 70% of optical energy is lost at the color filter 24, and thus total about 90% of optical energy is lost. Specifically, when the white light penetrates the color filter 24, about 70% are absorbed by the color filter 24, and only about 30% penetrates through the color filter 24. Accordingly, the loss of the white light in the color filter 24 is the main loss of the optical energy in the conventional direct type LCD, and thus although the color filter 24 is the core device for realizing a color image, the color filter 24 induces light loss by absorbing the white light.

Accordingly, a field sequential color (FSC) technology is being developed so as to increase light energy efficiency of an LCD. The FSC technology is designed to remove a color filter that causes the most light energy loss. In the FSC technology, RGB LEDs are used as light sources of a backlight, a screen image signal is divided into RGB image signals, the R image signal is quickly transmitted to a liquid crystal panel while the R LED is turned on, the G image signal is quickly transmitted to the liquid crystal panel while the G LED is turned on, and the B image signal is quickly transmitted to the liquid crystal panel while the B LED is turned on, thereby realizing a color image.

However, although the FSC technology is making remarkable progress, a speed of a circuit for adjusting an image needs to be about 6 times of a general circuit for adjusting an image, and flickering or color break-up may occur in an LCD using the FSC technology. Accordingly, the LCD using the FSC technology has not yet been put to practical use.

### DISCLOSURE OF INVENTION

### Technical Problem

The present invention provides a liquid crystal display (LCD), wherein power consumption is reduced by remarkably reducing light absorptance in a color filter while using a conventional liquid crystal panel and a conventional driving circuit without installing a separate high-speed driving circuit in a liquid crystal driving circuit and an image processing apparatus, unlike the field sequential color (FSC) technology.

The present invention also provides an LCD, wherein a loss of optical energy due to a color filter is reduced, power consumption of the LCD is reduced, and the number of light emitting diodes (LEDs) is reduced, by using a grouped lenticular lens array and a grouped R, G, B light source array.

### Technical Solution

According to an aspect of the present invention, there is provided a liquid crystal display including: a liquid crystal panel including front and rear glass substrates, a plurality of liquid crystal sub-pixels for red, green, and blue respectively corresponding to three color, i.e., red, green, and blue, lights, and disposed between the front and rear glass substrates, and a color filter disposed between the plurality of liquid crystal sub-pixels and the front glass substrate; a backlight unit disposed behind the liquid crystal panel, and including a plurality of three color light suppliers spaced apart from each other in groups and supplying the three color lights; and a lenticular lens array disposed between the backlight unit and the liquid crystal panel, and inducing the three color lights emitted from the three color light suppliers to the liquid crystal sub-pixels and the color filter of the liquid crystal panel.

The liquid crystal display may further includes a diffusion layer disposed between the color filter and the front glass substrate and/or outside the front glass substrate and diffusing incident light.

Each of the three color light suppliers comprises light emitting diodes (LEDs) emitting red, green, and blue lights. The LEDs may be a side-view type, and each may include a light guide for converting light of the LEDs into a linear light source according to total internal reflection. The liquid crystal display may further include a plurality of prisms at the rear surface of the light guide or a plurality of reverse prisms at the front surface of the light guide, as a light branching structure, so as to branch the light induced by the total internal reflection of the light guide in a vertical direction.

Each of the LEDs may further include circular lens having a circular plane or an oval lens having an oval plane in front thereof. Each of the LEDs may be molded to the corresponding circular lens or the oval lens. Each of the LEDs may further include a cylindrical light guide in front thereof, and a circular lens combined to one end of the cylindrical light guide. Each of the LEDs may further include a plate type light guide in front thereof, and a cylindrical lens combined to one end of the plate type light guide.

The diffusion layer may be formed of a transparent resin in which beads or particles are scattered. The diffusion layer may further include a light guide grid array in which a plurality of light guide grids are regularly arranged so as to guide a part of light diffused at the diffusion layer according to total internal reflection.

The lenticular lens array may include a plurality of lenticular lens groups each including a plurality of lenticular lenses, wherein the plurality of lenticular lens groups are spaced apart from each other in groups according to the plurality of three color light suppliers, and an interval between the adjacent lenticular lens groups is calculated according to Equation 1 below:

g=2T₁ tan Φₙ Equation 1

where T1 denotes a thickness of the rear glass substrate, pn denotes an angle of the light, which is refracted at one of the plurality of lenticular lenses after being incident on the lenticular lens and proceeding with respect to a direct upper part.

### Advantageous Effects

According to the LCD including the lenticular lens of the present invention, the grouped lenticular lens array is disposed between the liquid crystal panel and the LED rear plate, so as to emit RGB lights into the color filters disposed on the front glass substrate in front of the liquid crystal sub-pixels. Accordingly, light transmittance of the color filters is increased, and thus the light loss in the color filters is decreased, thereby reducing the power consumption of the LCD.

Also, the diffusion layer is disposed between the color filter and the front glass substrate or outside the polarizing sheet attached to the front glass substrate, thereby obtaining sufficient viewing angle and white balance.

In addition, light penetration efficiency is increased from about 100% to about 300%, and thus the manufacturing costs are reduced by remarkably reducing the number of LEDs. Also, the power consumption may be reduced from about 30% to about 80%.

Moreover, various optical sheets, such as a diffusion plate, a diffusion sheet, a prism sheet, and a reflective polarizing sheet, used for a backlight unit using a conventional white light source may not be used, and thus the price of the LCD may be decreased.

Further, the LCD of the present invention can use CCFLs or EEFLs emitting R, G, and B light used as light sources of a conventional LCD.

While the present invention has been particularly shown and described with reference to exemplary embodiments thereof, it will be understood by those of ordinary skill in the art that various changes in form and details may be made therein without departing from the spirit and scope of the present invention as defined by the following claims.

### BRIEF DESCRIPTION OF DRAWINGS

The above and other features and advantages of the present invention will become more apparent by describing in detail exemplary embodiments thereof with reference to the attached drawings in which:

FIG. 1 is a cross-sectional diagram of a conventional direct type liquid crystal display (LCD);

FIG. 2 is a plan view illustrating a structure of a color filter installed inside a front glass substrate of a liquid crystal panel of FIG. 1;

FIG. 3 is a cross-sectional diagram for describing a concept of an LCD including a lenticular lens array, according to an embodiment of the present invention;

FIG. 4 is a partial enlarged diagram of a liquid crystal panel and the lenticular lens array illustrated in FIG. 3;

FIG. 5 is a cross-sectional diagram illustrating a diffusion layer of FIG. 3, according to another embodiment of the present invention;

FIG. 6 is a perspective view of a light guide grid array illustrated in FIG. 5;

FIG. 7 is a perspective view of a light guide grid array illustrated in FIG. 6, according to an embodiment of the present invention;

FIG. 8 is a diagram for describing an optical principle of the light guide grid array of FIG. 5;

FIG. 9 is a perspective view of the lenticular lens array illustrated in FIG. 3;

FIG. 10 is a plan view illustrating an arrangement of light emitting diodes (LEDs), according to an embodiment of the present invention;

FIG. 11 is a diagram illustrating a stereoscopic structure of the LCD including the lenticular lens array of FIG. 3;

FIG. 12 is a diagram showing light distribution at a location where a liquid crystal sub-pixel of a liquid crystal panel illustrated in FIG. 3 is disposed;

FIG. 13 is plan views illustrating arrangements of LEDs, according to different embodiments of the present invention;

FIG. 14 is cross-sectional diagram and longitudinal-sectional diagram illustrating a structure of an LED package, according to an embodiment of the present invention;

FIGS. 15 and 16 are diagrams illustrating structures of an LED package, according to other embodiments of the present invention;

FIG. 17 is a plan view illustrating an arrangement of a light guide according to an embodiment of the present invention;

FIG. 18 is a cross-sectional diagram illustrating an LCD including a prism as a light branching structure, at the light guide of FIG. 17;

FIG. 19 is a cross-sectional diagram illustrating an LCD including a reverse prism as a light branching structure, at the light guide of FIG. 17;

FIG. 20 is a perspective view illustrating a structure of the reverse prism as a light branching structure illustrated in FIG. 19;

FIG. 21 is a perspective view illustrating an LCD including the light guide of FIG. 17;

FIG. 22 is a plan view illustrating an arrangement of a light guide according to another embodiment of the present invention;

FIG. 23 is a plan view illustrating an arrangement of a backlight unit according to an embodiment of the present invention; and

FIG. 24 is cross-sectional diagram and longitudinal-sectional diagram of a cold cathode fluorescence lamp (CCFL) and an external electrode fluorescence lamp (EEFL).

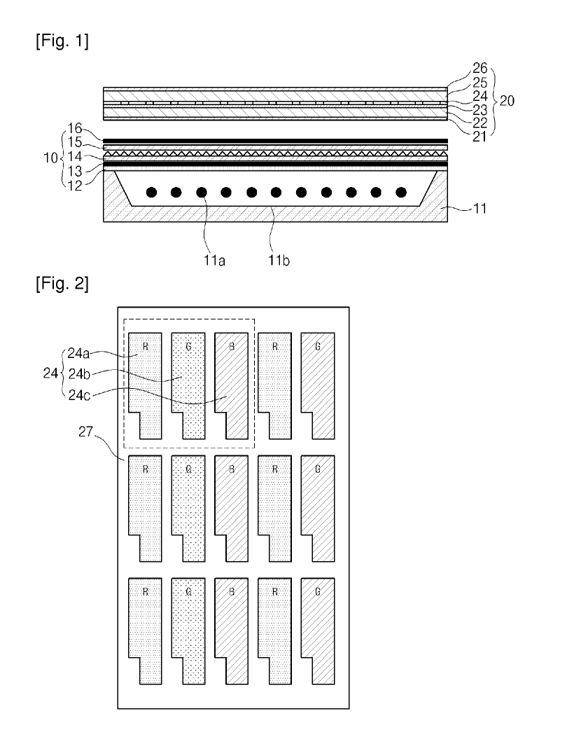

### MODE FOR THE INVENTION

Hereinafter, the present invention will be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Meanings of terms and words used herein are not limited to common or dictionary definitions, and are understood according to technical aspects of the present invention, because an inventor is allowed to define a term or word to best describe the invention.

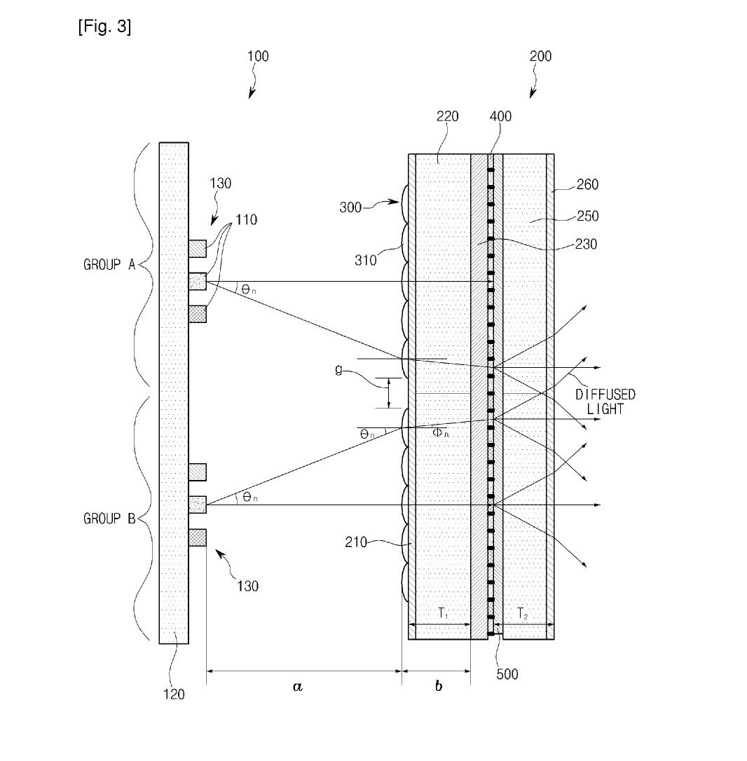

FIG. 3 is a cross-sectional diagram for describing a concept of a liquid crystal display (LCD) including a lenticular lens array 300, according to an embodiment of the present invention.

Referring to FIG. 3, the LCD includes a liquid crystal panel 200, a backlight unit 100, and the lenticular lens array 300.

The liquid crystal panel includes front and rear glass substrates 250 and 220, a plurality of liquid crystal sub-pixels 230, each for red (R), green (G), or blue (B), disposed between the front and rear glass substrate 250 and 220, and corresponding to respective three color, i.e., R, G, and B, lights, and color filters 400 for RGB and disposed between the liquid crystal sub-pixels 230 and the front glass substrate 250.

The backlight unit 100 is disposed behind the liquid crystal panel 200, and includes a plurality of three color, i.e., R, G, and B, light suppliers 130 for supplying the three color lights, wherein the three color light suppliers 130 are spaced apart from each other in groups. Here, each of the three color light suppliers 130 of the backlight unit 100 includes light emitting diodes (LEDs) 110 emitting RGB lights.

The lenticular lens array 300 is disposed between the liquid crystal panel 200 and the backlight unit 100, and induces the three color lights emitted from the three color light suppliers 130 to the liquid crystal sub-pixel 230 and the color filters 400 of the liquid crystal panel 200. Here, the lenticular lens array 300 includes a plurality of lenticular lens groups each including a plurality of lenticular lenses 310, wherein the lenticular lens groups are spaced apart from each other according to each of the three color light suppliers 130.

Here, the three color light suppliers 130 are disposed at an LED rear plate 120 in groups, and the lenticular lens array 300 is also disposed in groups corresponding to the three color light suppliers 130. The three color lights emitted from the three color light suppliers 130 of a group A from among groups A and B are incident to corresponding liquid crystal sub-pixels 230 and color filters 400 of the group A through the lenticular lenses 310 of the group A. Here, since the liquid crystal sub-pixels 230 are disposed at image forming points of the three color lights by the lenticular lenses 310, the three color lights form an image by being dispersed into the corresponding liquid crystal sub-pixels 230 and color filters 400. At this time, light emitted to the liquid crystal sub-pixel 230 and the color filter 400 at the edge of a group may be incident on a neighboring liquid crystal sub-pixel 230 and a neighboring color filter 400 through a neighboring lenticular lens 310, but such light is absorbed to and removed by the neighboring color filter 400 of a color different from the light, and thus the image quality is not affected. Also, when light is incident on another pixel due to, for example, aberration of the lenticular lens 310, the light is absorbed to and removed by the color filter 400 of the other pixel because the light has a different wavelength from light that is supposed to incident on the other pixel, and thus the image quality is not affected.

When a lenticular lens array sheet 350 is integrated to a polarizing sheet 210 and the rear glass substrate 220, a distance “a” between the three color light suppliers 130 and the lenticular lens array 300, a distance “b” between the lenticular lens array 300 and the liquid crystal sub-pixels 230, and a focal length “f” of the lenticular lens 310 establish Equation 2 below, which is an image forming formula of a lens.

$$\frac{1}{a} + \frac{n}{b} = \frac{n}{f} \qquad Equation 2$$

Here, n denotes an effective refractive index of the lenticular lens 310, the polarizing sheet 210, and the rear glass substrate 220. Magnification of the lenticular lens 310 may be M=n*a/b.

When the three color lights in the group A are irradiated on the lenticular lenses 310 in the group A, the neighboring groups of the lenticular lens array 300 may be spaced apart from each other according to a difference of angle of inclination of the three color lights. For example, G light emitted from the center of the group A may be obliquely incident to the lenticular lens 310 on the edge of the group A in an angle of θn, and may obliquely proceed downward in an angle of φ,

after being refracted at the lenticular lens 310 so as to be incident on the liquid crystal sub-pixel 230 for G and the color filter 400 for G disposed on the edge of the group A. Alternatively, the G light emitted from the center of the group B adjacent to the group A may be obliquely incident to the lenticular lens 310 on the edge of the group B in the angle of On, and may obliquely proceed upward in the angle of φ,

after being refracted at the lenticular lens 310 so as to be incident on the liquid crystal sub-pixel 230 for G and the color filter 400 for G disposed on the edge of the group B. Here, θn and φ,

may establish a relationship of

sin oₙ−n sin φₙ

according to Snell's law of refraction, wherein “n” denotes a refractive index of the lenticular lens 310. Since the liquid crystal sub-pixels 230 are disposed at regular interval, the lenticular lenses 310 that are adjacent to each other at the edges of the groups A and B are spaced apart from each other by an interval g, wherein g=2T₁ tan φₙ.

Here, T1 denotes a thickness of the lenticular lens array sheet 350 and the rear glass substrate 220. As the liquid crystal sub-pixel 230 that is disposed at the center of the same group, for example the liquid crystal sub-pixel 230 for G, moves to the edge of the group, the location of the liquid crystal sub-pixel 230 moves away from the center location of the corresponding lenticular lens 310 according to a light refractive effect. Such a difference in location may be calculated according to

Δyₙ−T₁ tan φₙ

As described above, when lights from the three color light suppliers 130 are incident on the liquid crystal sub-pixels 230 and the color filters 400 after being emitted to the lenticular lenses 310, the lights incident on the liquid crystal sub-pixels 230 in different groups may proceed in different directions, and thus luminance and chromaticity may be different according to a viewing angle.

Accordingly, the LCD according to the current embodiment of the present invention includes a diffusion layer 500 between the color filters 400 and the front glass substrate 250 or outside the front glass substrate 250 so as to diffuse incident light. In FIG. 3, a reference numeral 260 denotes a polarizing sheet.

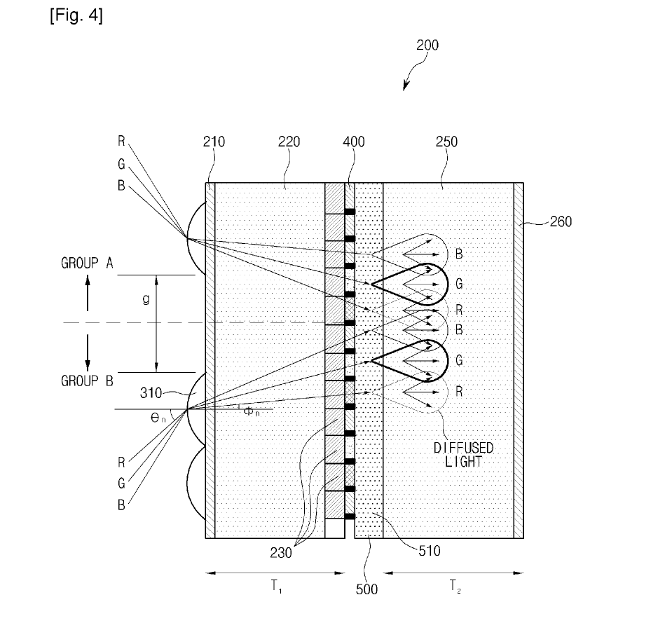

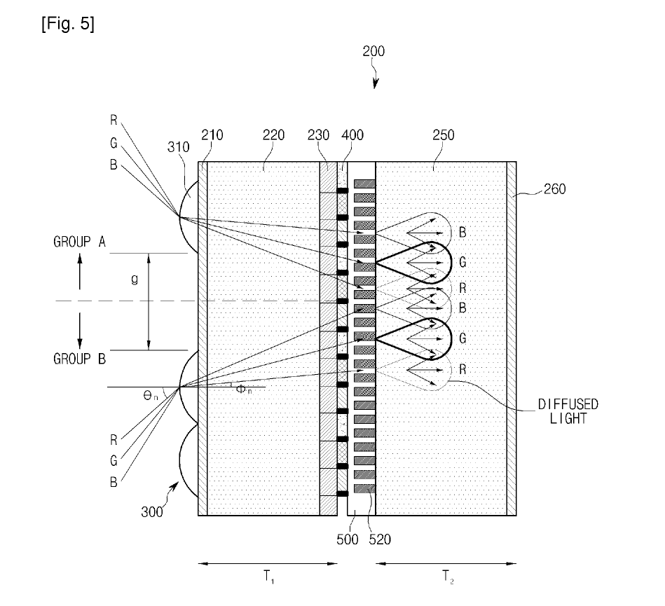

The diffusion layer 500 according to an embodiment of the present invention will now be described with reference to FIGS. 4 and 5. FIG. 4 is a partial enlarged diagram of the liquid crystal panel 200 and the lenticular lens array 300 illustrated in FIG. 3, and FIG. 5 is a cross-sectional diagram illustrating the diffusion layer 500 of FIG. 3, according to another embodiment of the present invention.

As shown in FIG. 4, the diffusion layer 500 according to an embodiment of the present invention may be a particle dispersed diffusion layer formed of a transparent resin, in which a plurality of transparent beads 510 or minute particles having a different refractive index from the resin are scattered. Accordingly, the three color lights that passed through the liquid crystal sub-pixels 230 are emitted in parallel regardless of an incident angle and diffused top, bottom, right, and left by the diffusion layer 500. Accordingly, a viewer may obtain a sufficient viewing angle, and a difference in chromaticity or luminance according to a viewing angle may be minimized.

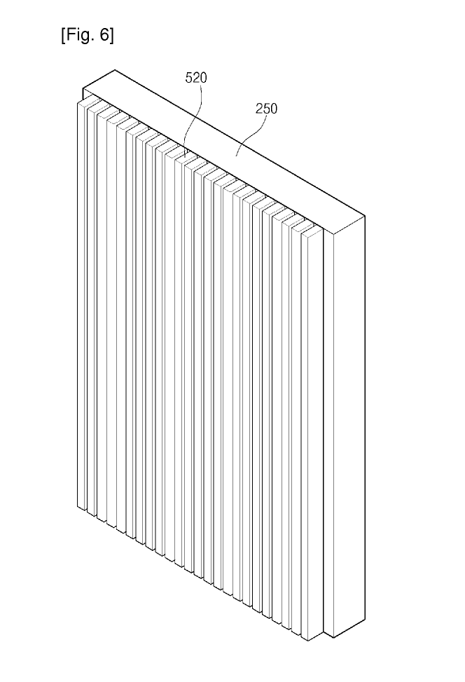

Alternately, as shown in FIG. 5, the diffusion layer 500 may include a light guide grid array including a plurality of light guide grids 520 that are regularly arranged, so as to guide a part of the light diffused at the diffusion layer 500 according to total internal reflection. The diffusion layer 500 including the light guide grid array will now be described in detail with reference to FIGS. 6, 7, and 8.

First, the diffusion layer 500 in which the beads 510 or the minute particles are scattered in the transparent resin may not be sufficiently diffuse the light while paralleling the directions of the light. Accordingly, in order to strengthen a light diffusing function, the diffusion layer 500 may further include the light guide grids 520 formed of a transparent material and having a refractive index higher than the resin included in the diffusion layer 500 of FIG. 4, as shown in FIG. 5. In other words, the diffusion layer 500 of FIG. 5 may be formed by combining the light guide grids 520 to the diffusion layer 500 of FIG. 4 including the beads 510 or the minute particles.

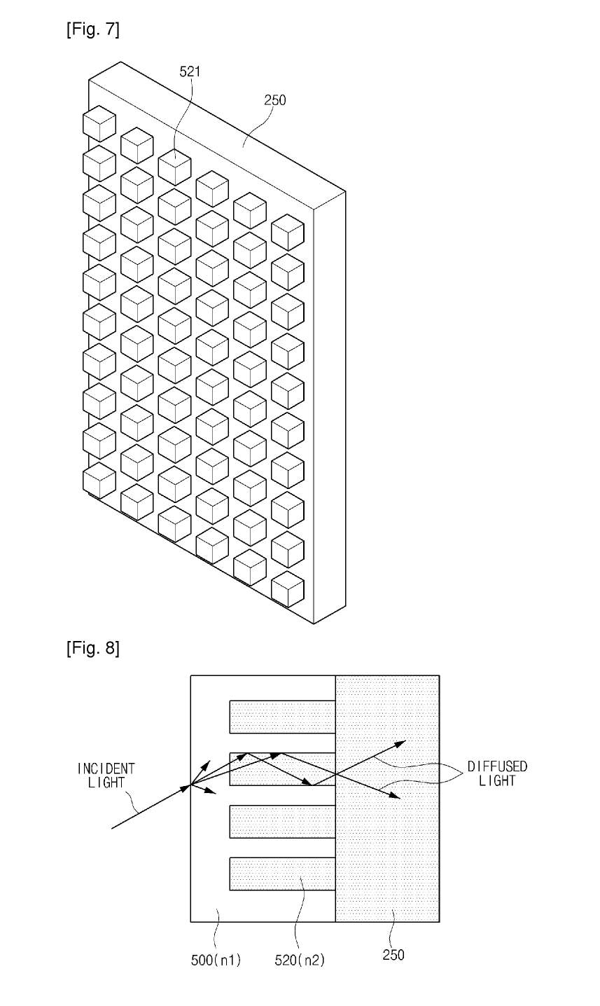

The light guide grid 520 may have a transparent 1-dimensional uneven structure that is parallel to a length direction of the lenticular lens 310 as shown in FIG. 6. Alternatively, a light guide grid 521 may have a transparent 2-dimensional uneven rectangular structure as shown in FIG. 7. However, the structures of the light guide grids 520 and 521 are the embodiments of the present invention, and thus may be cylindrical having the same light guiding function as the light guide grids 520 and 521. Meanwhile, the light guide grid 520 may be disposed on the LCD in the width from 1 μm to 100 μm, height from 1 μm to 100 μm, and pitch from 2 μm to 100 μm, and the pitch may be 1.1 to 3 times of the width. A ratio of the width to height of the light guide grid 520 may be from 1:1 to 1:30.

The diffusion layer 500 may be disposed between the color filters 400 and the front glass substrate 250, outside the front glass substrate 250, or both between the color filters 400 and the front glass substrate 250 and outside the front glass substrate 250, thereby increasing uniformity of light and viewing angle.

FIG. 8 is a diagram for describing an optical principle of the light guide grids 520 and 521. Referring to FIG. 8, an incident light that is obliquely incident on the diffusion layer 500 is diffused by the diffusion layer 500, in which the beads 510 or minute particles are dispersed. A part of the diffused light enters the light guide grid 520 or 521, is guided according to total internal reflection, and thus is emitted in up-down symmetry toward the front of the LCD. Here, a refractive index n2 of the light guide grid 520 or 521 is bigger than a refractive index n1 of the resin included in the diffusion layer 500.

In other words, when the light is incident on the diffusion layer 500, the light diffused by the diffusion layer 500 is guided by the light guide grid 520 or 521, and thus the directivity of the diffused light toward the front of the LCD is increased. In detail, when the light diffused at the diffusion layer 500 enters the light guide grid 520 or 521, the light proceeds along the light guide grid 520 or 521 according to the total internal reflection regardless of the incident direction of the light, and then is diffused and emitted. Accordingly, the three color light may be diffused in parallel to each other to the front of the LCD, regardless of the incident angle. Accordingly, both light entering the lenticular lens 310 and the liquid crystal sub-pixels 230 disposed at the center of a group and light obliquely entering the lenticular lens 310 and the liquid crystal sub-pixels 230 disposed at the edge of the group are diffused in the same angle to the front of the LCD by the light guide grid 520 or 521. Consequently, a difference in chromaticity or luminance according to a viewing angle is decreased, and thus the excellent color quality is obtained.

Since the LCD according to the current embodiment of the present invention is a device for realizing an image by using polarization conversion, a material of the diffusion layer 500, a material of the bead 510, and a material of the light guide grid 520 or 521 may not be optically anisotropic so that the diffusion layer 500 does not generate polarization conversion. In other words, the resin, the beads 510 scattered in the resin, and the light guide grid 520 or 521 included in the diffusion layer 500 may be formed of an optically isotropic material.

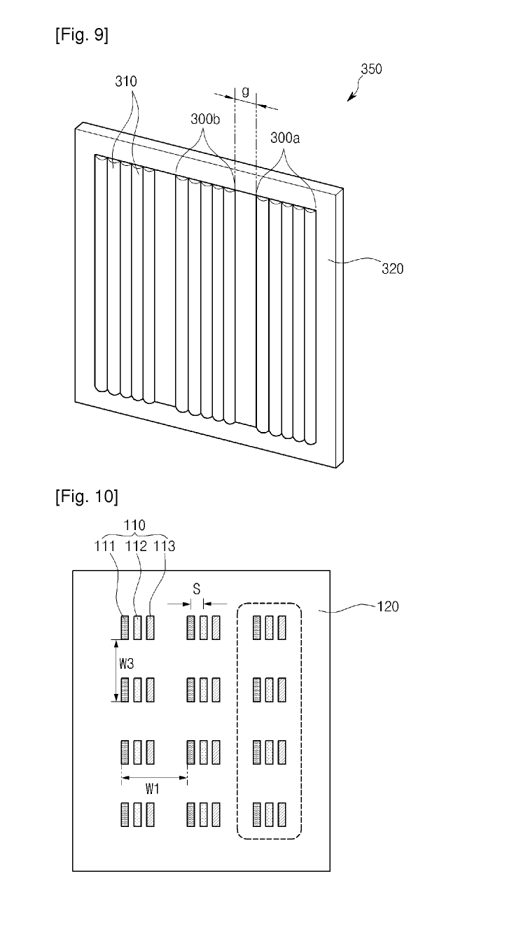

FIG. 9 is a perspective view of the lenticular lens array 300 illustrated in FIG. 3. Referring to FIG. 9, in the lenticular lens array 300, a plurality of lenticular lens groups 300a and 300b, each including a plurality of lenticular lenses 310, are spaced apart from each inter in groups according to the three color light suppliers 130. Here, an interval g between the adjacent lenticular lens groups 300a and 300b may be calculated according to Equation 1 below.

g=2T₁ tan φₙ Equation 1

Here, T₁ denotes a thickness of the rear glass substrate 220, and φₙ

denotes an angle of the light, which is refracted at the lenticular lens 310 after being incident on the lenticular lens 310 and proceeding with respect to a direct upper part.

The lenticular lens array 300 may be formed on a substrate formed of a transparent optical material. The substrate may be formed of a transparent plastic sheet, a transparent glass or a plastic panel. The lenticular lens array 300 and the substrate are integrated to each other to form a lenticular lens array sheet 350. The lenticular lens array sheet 350 is attached to the polarizing sheet 210 and may be integrated to the rear glass substrate 220 of the liquid crystal panel 200. The lenticular lens 310 may have a convex lens shape in a horizontal direction, and a linear shape in a vertical direction, thereby changing a point light source to an image in a vertical direction, i.e., a linear image. When the plurality of lenticular lenses 310 are arranged in parallel so as to form the lenticular lens array 300, one point light source may form a plurality of linear images. Also, a shape of the lenticular lens 310 is basically a hemispherical cylinder, but may be aspherical instead of circular in order to improve aberration and performance of the lenticular lens 310.

FIG. 10 is a plan view illustrating an arrangement of the LEDs 110, according to an embodiment of the present invention.

Referring to FIG. 10, an R LED 111, a G LED 112, and a B LED 113 disposed adjacent to each other form one group, and such groups of LEDs 110 are regularly disposed top, bottom, right, and left on the LED rear plate 120. Here, a distance W3 between the LEDs 110 in a top and bottom direction is determined based on light intensity of an LED chip and a distance between the LED rear plate 120 and the liquid crystal panel 200, and may be in the range from several mm to tens of cm. According to an embodiment of the present invention, lights emitted from the neighboring LEDs 110 in the top and bottom direction in the same group may overlap in the lenticular lens 310 and the liquid crystal sub-pixels 230, thereby increasing uniformity of the light.

A horizontal distance S between the R LED 111, the G LED 112, and the B LED 113 is determined according to magnification of the lenticular lens 310. When M denotes the magnification of the lenticular lens 310 and h denotes a distance between the liquid crystal sub-pixels 230, S=M*h. For example, when M=10 and g=0.15 mm, S=1.5 mm. M and g are determined based on a size of the LCD and a size of the backlight unit 100, and S may be in the range of about 0.5 mm to about 5 mm.

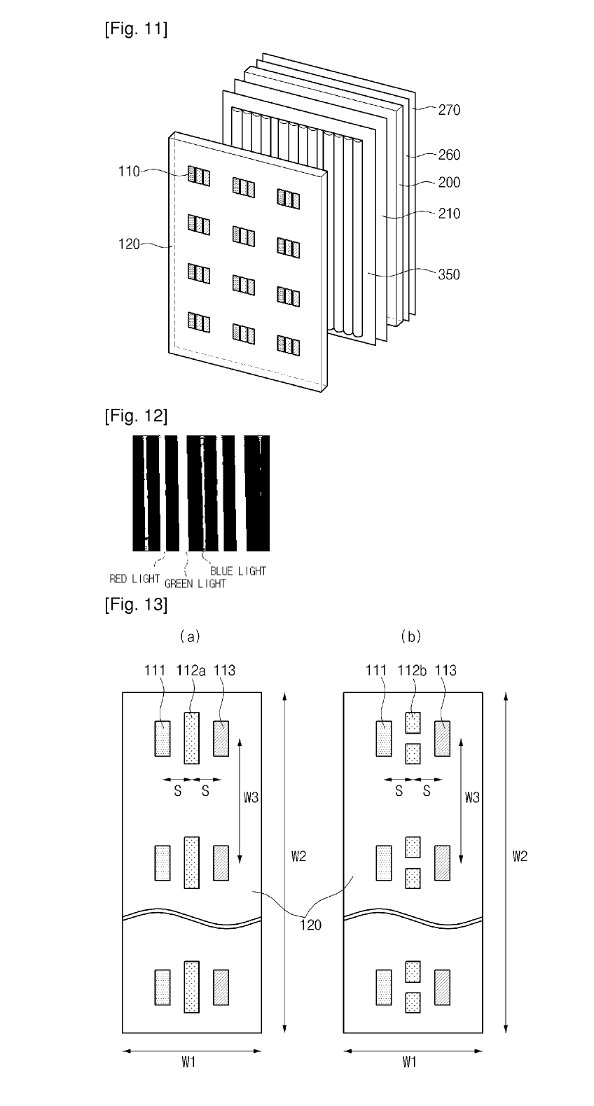

FIG. 11 is a diagram illustrating a stereoscopic structure of the LCD including the lenticular lens array 300 of FIG. 3.

Referring to FIG. 11, the LEDs 110 are regularly disposed in horizontal and vertical directions on a front surface of the LED rear plate 120. The LED rear plate 120 may include an electronic device and wires for supplying a current to the LEDs 110, and at the same time, may have a function for removing heat generated in the LEDs 110 or include a heat removing device. The lenticular lens array sheet 350 may be integrated to the liquid crystal panel 200 to which the polarizing sheet 210 is attached.

FIG. 12 is a diagram showing light distribution at a location where the liquid crystal sub-pixels 230 of the liquid crystal panel 200 illustrated in FIG. 3 are disposed. The light distribution is measured by using the LEDs 110 as light sources, and the lenticular lens array 300. As shown in FIG. 12, red, green, and blue lights form linear images in a top and bottom direction at regular interval from the color filters 400 of the liquid crystal sub-pixels 230.

FIG. 13 is plan views illustrating arrangements of LEDs 110, according to different embodiments of the present invention, for describing a method of obtaining white light by balancing the light intensity of the LEDs 110. According to the method, the size of the G LED 112 is enlarged or the number of the G LEDs 112 is increased, since the light intensity of green light needs to be higher than the light intensities of the red and blue lights so as to obtain the white light. In detail, a G LED 112a having a larger size than the R and B LEDs 111 and 113 may be formed on the LED rear plate 120, such as a printed circuit board (PCB) or a metal core PCB (MCPCB) including a heat radiating function, as shown in FIG. 13(a), or two G LEDs 112b may be formed on the LED rear plate 120, as shown in FIG. 13(b), so as to supply required light intensity.

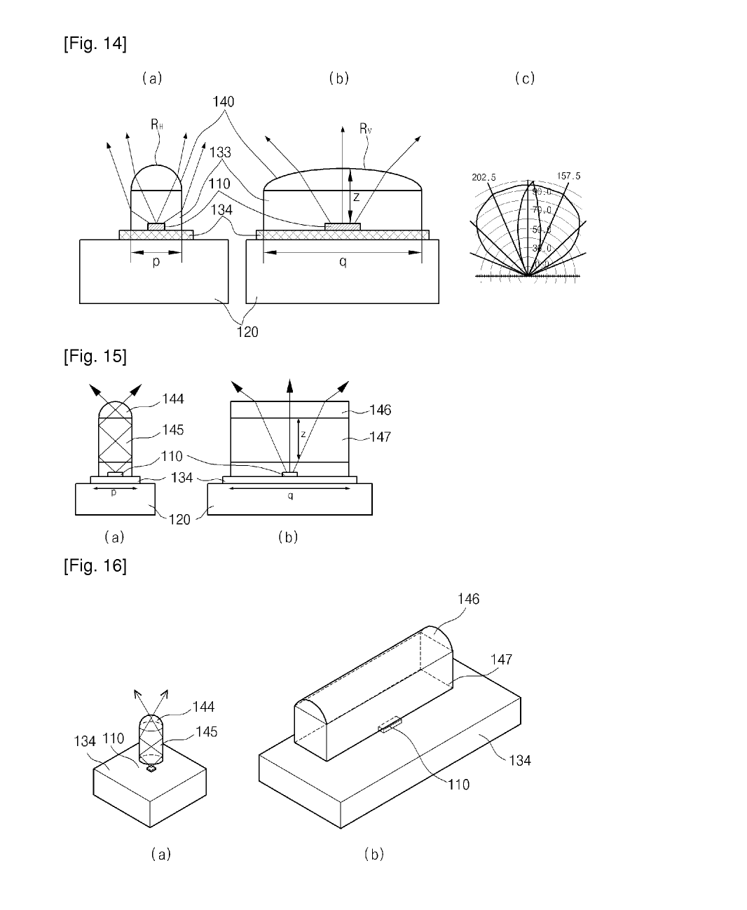

A method of improving light efficiency by adjusting an emitting angle of light from the LED 110 as described in FIG. 13 will now be described with reference to FIG. 14. FIG. 14 is cross-sectional diagram and longitudinal-sectional diagram illustrating a structure of an LED package, according to an embodiment of the present invention. An oval lens 140 having an oval plane or a circular lens having a circular plane may be formed in front of the LED 110 in order to adjust the emitting angle of the light emitted from the LEDs 110 in one group. Accordingly, light energy as much as possible enters into the lenticular lens 300 in the same group, and thus the light efficiency is increased.

In order to emit the light from the LED 110 with a narrow emitting angle in a horizontal direction as shown in FIG. 14(a), the radius of curvature of the oval lens 140 disposed in front of the LED 110 may be decreased. On the other hand, in order to emit the light from the LED 110 with a wide emitting angle in a vertical direction as shown in FIG. 14(b), the radius of curvature of the oval lens 140 may be increased.

As such, when the radii of curvature are different in the horizontal and vertical directions, the oval lens 140 is formed. The LED 110 is molded into a transparent resin 133 having a width p and a length q, by a depth z, and the surfaces of the transparent resin 133 may be oval, wherein the width, the length, and the radius of curvature are different from each other, so that the emitting angles in the horizontal and vertical directions are different.

Here, the width p of the transparent resin 133 may be from 0.5 mm to 5 mm according to the size of the LCD. Here, the length q of the transparent resin 133 may be larger than the width p, and may be from 2 mm to 30 mm.

FIG. 14(c) shows a simulation result of light emission of the LED 110 using the oval lens 140, according to an optical simulation program. In FIG. 14(c), it is seen that the luminances along the horizontal and vertical directions are different. The difference in the luminance of the LED 110 in the horizontal and vertical directions is determined based on the radius of curvature R_{H} in the horizontal direction, the radius of curvature R_{V} in the vertical direction, and the depth z of the LED 110 embedded in the transparent resin 133.

As described above, the major axis and the minor axis of the oval lens 140 formed on the transparent resin 133 are determined respectively based on the width p and the length q of the transparent resin 133. Also, the radius of curvature is determined based on the emitting angle, and since the radius of curvature R_{H} has a narrow emitting angle, a ratio of the depth z to the radius of curvature R_{H} (z/R_{H}) may be from 1 to 3. For example, when the width p is 2 mm, the radius of curvature R_{H} is 1 mm, the depth z may be from 1 mm to 3 mm. Also, since the radius of curvature R_{V} has a wide emitting angle, z/R_{V} may be from 0.1 to 1. For example, when the length q is 6 mm, the radius of curvature R_{V} is 3 mm, and the depth z is 2 mm, z/R_{V} is 0.67. Here, when the radii of curvature R_{H} and R_{V} are the same, a circular lens is formed. When a plurality of medium and low luminance LEDs are adjacently disposed, sufficient light uniformity may be obtained even by using the circular lens. When the circular lens is used, the LEDs may be manufactured with low costs. In FIG. 14, a reference numeral 134 denotes an LED chip mount.

The LED 110 may include the circular lens or the oval lens 140 may molding the circular lens or the oval lens 140 by using the transparent resin 133.

FIGS. 15 and 16 are diagrams illustrating structures of an LED package, according to other embodiments of the present invention. FIG. 15(a) is a cross-sectional diagram of the structure of LED package, FIG. 15(b) is a longitudinal-sectional diagram of the structure of the LED package, and 14B (a) and (b) are perspective views of the structures of the LED package respectively shown in FIG. 15(a) and FIG. 15(b). The LED 110 according to an embodiment of the present invention may include a cylindrical light guide 145 in front of the LED 110, and a circular lens 144 having a circular plane and combined to one end of the cylindrical light guide 145, as shown in FIGS. 15(a) and 16(a). Alternately, the LED 110 according to another embodiment of the present invention may include a plate type light guide 147 in front of the LED 110, and a cylindrical lens 146 combined to one end of the plate type light guide 147, as shown in FIGS. 15(b) and 16(b). Such structures will now be described in detail.

When the LED 110 includes the cylindrical light guide 145 and the circular lens 144 at the one end of the cylindrical light guide 145 as shown in FIG. 15(a), the light emitted from the LED 110 is totally reflected inside the cylindrical light guide 145 as shown in FIG. 16(a), and thus the light is mixed. Accordingly, uniformity and a diffusing angle of the light increase. Alternately, when the LED 110 includes the plate type light guide 147 and the cylindrical lens 146 at the one end of the plate type light guide 147 as shown in FIGS. 15(b) and 16(b), the light emitted from the LED 110 may be mixed well, and diffusing angles of the light in vertical and horizontal directions may be adjusted to be different. Accordingly, light efficiency and uniformity may be increased.

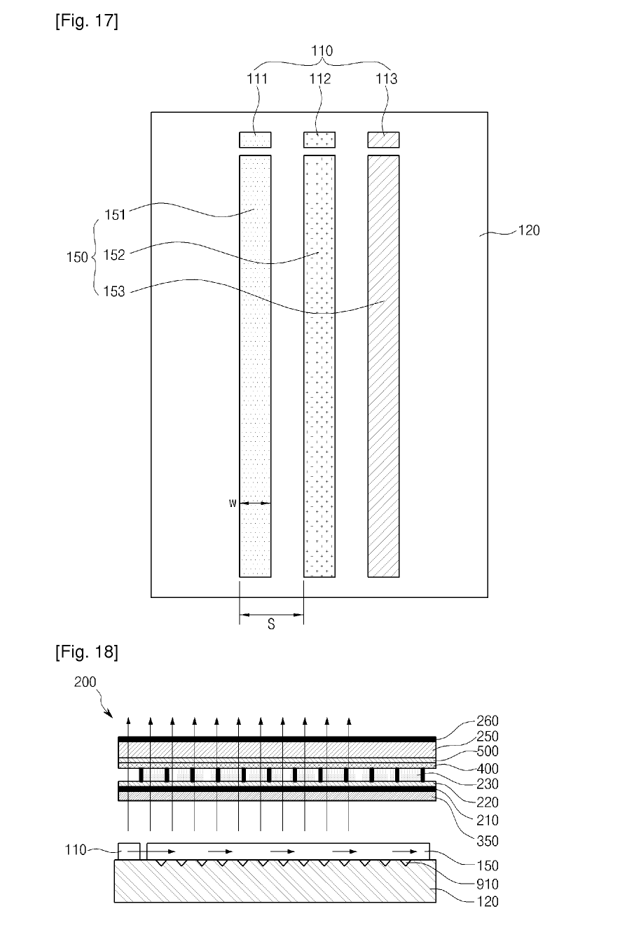

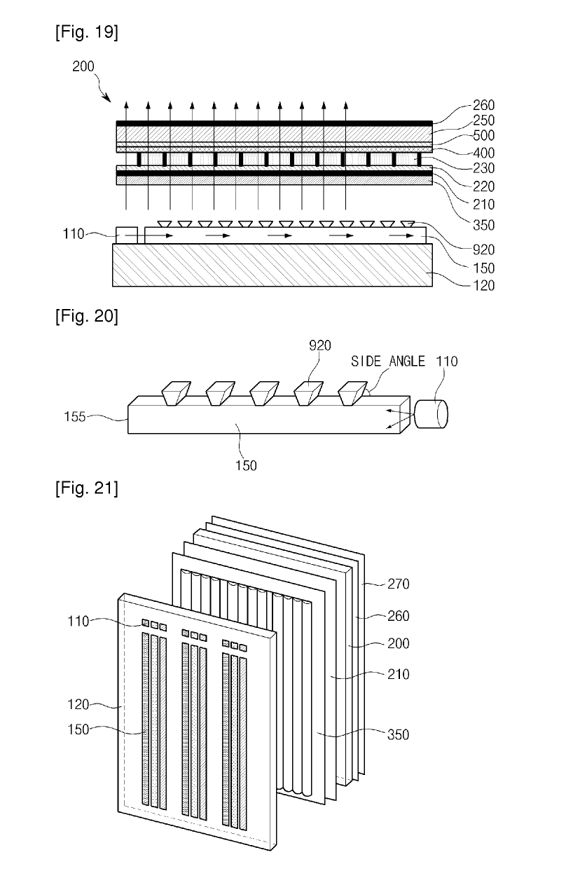

The LCD including the lenticular lens 310 including a light guide 150 will now be described with reference to FIGS. 17 through 20. FIG. 17 is a plan view illustrating an arrangement of the light guide 150 according to an embodiment of the present invention, and FIG. 18 is a cross-sectional diagram illustrating the LCD including a prism 910 as a light branching structure, at the light guide 150 of FIG. 17. FIG. 18 is a cross-sectional diagram illustrating the LCD including a reverse prism 920 as a light branching structure, at the light guide 150 of FIG. 17, and FIG. 20 is a perspective view illustrating a structure of the reverse prism 920 as a light branching structure illustrated in FIG. 19.

In the LCD according to an embodiment of the present invention, the LED 110 is a side emission type, the light of the LED 110 is incident on the light guide 150 disposed on the LED rear plate 120 so as to convert the light into a linear light source.

In FIG. 17, a point light source is converted into three parallel RGB linear light sources by using the R, G, and B LEDs 111, 112, and 113, and R, G, and B light guides 151, 152, and 153. The light emitted from the R LED 111 enters the R light guide 151 disposed straight in a top and bottom direction, and proceeds along the R light guide 151 according to total internal reflection. Similarly, the lights emitted from the G LED 112 and the B LED 113 respectively enter and proceed along the G light guide 152 and the B light guide 153. An interval between the R, G, and B light guides 151, 152, and 153 may be calculated by using S=M*h, as in the LEDs 110. Here, M denotes the magnification of the lenticular lens 310 and h denotes a distance between the liquid crystal sub-pixels 230.

A width w of the light guide 150 is formed by the lenticular lens array 300 and is determined according to a width e of the liquid crystal sub-pixels 230. Since the lenticular lens 310 reduces the width w of the light guide 150 by the magnification M, w=M*e. However, the width w may be larger than M*e in order to increase the error tolerance while arranging the LEDs 110.

The light guide 150 includes a light branching structure on the surface thereof, in order to bend the light proceeding inside the R, G, and B light guides 151, 152, and 153 according to the total internal reflection by 90 toward the lenticular lens array 300.

Such a light branching structure for branching the light, which is proceeding inside the light guide 150 according to the total internal reflection, in a vertical direction may be a plurality of prisms 910 disposed on the bottom surface of the light guide 150 as shown in FIG. 18, or a plurality of reverse prisms 920 disposed on the top surface of the light guide 150 as shown in FIGS. 19 and 20. A side angle of the prism 910 or a side angle of the prism 920 is determined so that the bent light proceeds vertically, and may be from 20° to 80°. Here, the light proceeding along the light guide 150 according to the total internal reflection is bent by 90° by the light branching structure shown in FIG. 18 or 19, and thus proceeds toward the lenticular lens array 300.

FIG. 21 is a perspective view illustrating an LCD including the light guide 150 of FIG. 17. The light guides 150 grouped according to R, G, and B are disposed on the LED rear plate 120. The LEDs 110 are each disposed at the upper or lower end of the light guide 150, thereby supplying the light into the light guide 150.

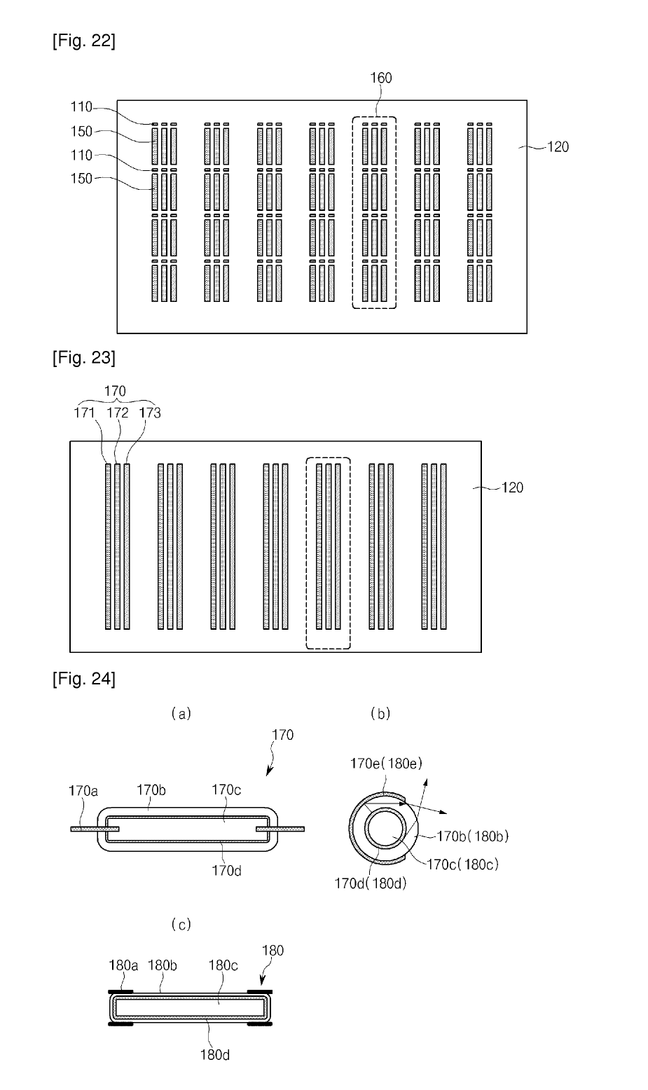

FIG. 22 is a plan view illustrating an arrangement of the light guide 150 according to another embodiment of the present invention. A plurality of the LEDs 110 and the corresponding light guides 150 are disposed on the top, bottom, right, and left of the LED rear plate 120. If each LED 110 and the light guide 150 for uniformly and vertically branching the light from the LED 110 are unable to supply the light amount required by the liquid crystal panel 200, the LEDs 110 and the light guides 150 may be divided into a plurality of groups 160 as shown in FIG. 22, so as to supply the required light amount to the liquid crystal panel 200. The number of groups 160 is determined based on the brightness of the LEDs 110, and may be from 1 to 50 in a horizontal direction and from 1 to 30 in a vertical direction.

FIG. 23 is a plan view illustrating an arrangement of a backlight unit according to an embodiment of the present invention, and FIG. 24 is cross-sectional diagram and longitudinal-sectional diagram of a cold cathode fluorescence lamp (CCFL) 170 and an external electrode fluorescence lamp (EEFL) 180. In detail, FIG. 23 is a plan view of the CCFLs 170 emitting R, G, and B light in the backlight unit 100, and FIG. 24 is a cross-sectional diagram and a longitudinal-sectional diagram of the CCFL 170 and the EEFL 180.

Referring to FIGS. 23 and 24, in the LCD according to the current embodiment of the present invention, the three color light supplier 130 may be one of the CCFLs 170 emitting R, G, and B light, and the EEFLs 180 emitting R, G, and B light.

In FIGS. 23 and 24, the backlight unit 100 uses the CCFLs 170 emitting R, G, and B light or the EEFLs emitting R, G, and B light as light sources, instead of the LEDs 110 and the light guides 150. When the CCFL 170 or the EEFL 180 is used as a light source, the CCFLs 170 emitting R, G, and B light or the EEFLs 180 emitting R, G, and B light are respectively disposed on locations of the light guides 150 emitting R, G, and B light of FIG. 21, and thus a linear light source is simply formed.

An R-CCFL 171 is coated with a phosphor emitting red therein, a G-CCFL 172 is coated with a phosphor emitting green therein, and a B-CCFL 173 is coated with a phosphor emitting blue therein. When the CCFL 170 or the EEFL 180 is used as a light source, the LED rear plate 120 may be formed of a nonconductive material, such as plastic, instead of being a PCB or MCPCB in which an electronic circuit is installed.

The light emitted from the CCFL 170 or the EEFL 180 is reflected at the surface of the LED rear plate 120 and then is incident on the lenticular lens array 300. Accordingly, the surface of the LED rear plate 120 is black and white in order to prevent the image quality from being deteriorated.

As shown in FIG. 24, the CCFL 170 may include an electrode 170a exposed at each end of a glass pipe 170b, a cylindrical phosphor 170d disposed inside the glass pipe 170b, and a discharge gas 170c is filled inside the cylindrical phosphor 170d.

Similarly, the EEFL 180 used as a light source includes a cylindrical phosphor 180d inside a glass pipe 180b and a discharge gas 180c filled inside the cylindrical phosphor 180d, but unlike the CCFL 180, an electrode 180a is not disposed inside the glass pipe 180b, but is deposited at each external end of the glass pipe 180b.

Here, since light is not required to be emitted to the LED rear plate 120, a reflective layer 170e and 180e may be respectively formed on the rear surface of the CCFL 170 and the EEFL 180 by coating the rear surface with a metal or forming a reflective film including scatterers, so that all lights are directly incident on the liquid crystal panel 200 through the lenticular lens array 300.

As described above, the LCD according to the embodiments of the present invention uses a grouped lenticular lens array without having to install a separate high-speed driving circuit in a liquid crystal driving circuit and an image processing apparatus, thereby decreasing loss of optical energy in a color filter, decreasing the power consumption of the LCD, and decreasing the number of LEDs.

1. A liquid crystal display comprising:
a liquid crystal panel comprising front and rear glass substrates, a plurality of liquid crystal sub-pixels for red, green, and blue respectively corresponding to three color, i.e., red, green, and blue, lights, and disposed between the front and rear glass substrates, and a color filter disposed between the plurality of liquid crystal sub-pixels and the front glass substrate;
a backlight unit disposed behind the liquid crystal panel, and comprising a plurality of three color light suppliers spaced apart from each other in groups and supplying the three color lights; and
a lenticular lens array disposed between the backlight unit and the liquid crystal panel, and inducing the three color lights emitted from the three color light suppliers to the liquid crystal sub-pixels and the color filter of the liquid crystal panel.

2. The liquid crystal display of claim 1, further comprising a diffusion layer disposed at least between the color filter and the front glass substrate and outside the front glass substrate and diffusing incident light.

3. The liquid crystal display of claim 1, wherein each of the three color light suppliers comprises light emitting diodes (LEDs) emitting red, green, and blue lights.

4. The liquid crystal display of claim 3, wherein the LEDs are a side-view type, and each comprises a light guide for converting light of the LEDs into a linear light source according to total internal reflection.

5. The liquid crystal display of claim 4, further comprising a plurality of prisms at the rear surface of the light guide or a plurality of reverse prisms at the front surface of the light guide, as a light branching structure, so as to branch the light induced by the total internal reflection of the light guide in a vertical direction.

6. The liquid crystal display of claim 3, wherein each of the LEDs further comprises a circular lens having a circular plane or an oval lens having an oval plane in front thereof.

7. The liquid crystal display of claim 6, wherein each of the LEDs is molded to the corresponding circular lens or the oval lens.

8. The liquid crystal display of claim 3, wherein each of the LEDs further comprises a cylindrical light guide in front thereof, and a circular lens combined to one end of the cylindrical light guide.

9. The liquid crystal display of claim 3, wherein each of the LEDs further comprises a plate type light guide in front thereof, and a cylindrical lens combined to one end of the plate type light guide.

10. The liquid crystal display of claim 2, wherein the diffusion layer is formed of a transparent resin in which beads or particles are scattered.

11. The liquid crystal display of claim 10, wherein the diffusion layer further comprises a light guide grid array in which a plurality of light guide grids are regularly arranged so as to guide a part of light diffused at the diffusion layer according to total internal reflection.

12. The liquid crystal display of claim 1, wherein the lenticular lens array comprises a plurality of lenticular lens groups each comprising a plurality of lenticular lenses, wherein the plurality of lenticular lens groups are spaced apart from each other in groups according to the plurality of three color light suppliers, and an interval between the adjacent lenticular lens groups is calculated according to Equation 1 below:
g=2T₁ tan φₙ Equation 1
where T1 denotes a thickness of the rear glass substrate, φn denotes an angle of the light, which is refracted at one of the plurality of lenticular lenses after being incident on the lenticular lens and proceeding with respect to a direct upper part.

13. The liquid crystal display of claim 2, wherein each of the three color light suppliers comprises light emitting diodes (LEDs) emitting red, green, and blue lights.
